(19) United States
(12) Patent Application Publication
(10) Pub. No.: US 2020/0147646 A1
(43) Pub. Date: May 14, 2020

(54) A SCREEN

(71) Applicant: AQSEPTENCE GROUP PTY LTD, Queensland (AU)

(72) Inventors: David John LAZZARINI, Queensland (AU); Yusuf CAJEE, Queensland (AU); Ian Robert SOLOMON, Queensland (AU); Steven Paul COLEMAN, Queensland (AU)

(73) Assignee: AQSEPTENCE GROUP PTY LTD, Queensland (AU)

(21) Appl. No.: 16/630,634

(22) PCT Filed: Jul. 20, 2018
(86) PCT No.: PCT/AU2018/050761

§ 371 Date: Jan. 13, 2020

(30) Foreign Application Priority Data
Jul. 20, 2017 (AU) 2017902842

(51) Int. Cl. B07B 1/06; B07B 1/12; B07B 1/18; B07B 1/46

(52) U.S. Cl. CPC B07B 1/06; B07B 1/4609; B07B 1/18; B07B 1/12

(57) ABSTRACT

A screen includes a support structure. A plurality of elongate screening elements are arranged in spaced relationship transversely on the support structure to define elongate screening apertures between adjacent screening elements. Each screening element has a screening head defining a screening surface, the screening surfaces all being at the same height relative to the support structure. Adjacent screening elements are of different widths relative to each other with a transverse dimension of the aperture being less than a width dimension of the wider screening element. The screening head of the wider screening element is shaped to maintain a substantially constant screening aperture between the screening elements during a predetermined amount of wear of the wider screening element.

### CROSS-REFERENCE TO RELATED APPLICATIONS

The present application claims priority from Australian Provisional Patent Application No 2017902842 filed on 20 Jul. 2017, the contents of which are incorporated herein by reference in their entirety.

### TECHNICAL FIELD

This disclosure relates, generally, to a screen and, more particularly, to a screen for screening and/or classifying material.

### BACKGROUND

Screens of various configurations are used in numerous applications. For example, in the mining industry, screens are used for media recovery, ore particle classification, dewatering or the like. Such screens are generally configured in the form of screening panels or sieve bends.

In other applications, screens are used for purification such as in water extraction with such screens generally being cylindrical in configuration. Cylindrical screens are also used in other applications such as in food preparation/processing, etc.

In all applications, there is a benefit in increasing open area of the screen per unit of screening area. However, in increasing open area certain other disadvantages may arise such as lack of longevity of the screen, possibly increased flexibility of screening elements resulting in larger than desired particles passing through the screen thereby reducing screening efficiency, etc. For example, in media recovery, inefficient media recovery can cost a mine operation significant sums of money. Recovery of media is directly related to the open area of the screen and its cut point (the size of the fraction passing through the screen).

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In a first embodiment of the disclosure, there is provided a screen which includes

a support structure; and

a plurality of elongate screening elements arranged in spaced relationship transversely on the support structure to define elongate screening apertures between adjacent screening elements, each screening element having a screening head defining a screening surface with the screening elements being arranged on the support structure so that the screening surfaces of all of the screening elements are at the same height relative to the support structure, the screening elements being arranged in pairs of different widths relative to each other and the screening aperture defined between each of the pairs of adjacent screening elements having a transverse dimension less than a maximum width dimension of a wider of the screening elements, the screening head of at least the wider screening element of each pair being shaped to maintain a substantially constant screening aperture between the pairs of screening elements during a predetermined amount of wear of at least the wider screening element.

It will be appreciated that, with respect to the pairs of adjacent elements, the screening elements being of different widths results in screening surfaces of different widths on opposed sides of the screening aperture between the pair of adjacent screening elements.

In a second embodiment of the disclosure, there is provided a screen which includes

a support structure which has the form of one of: a cylinder and a frustum; and

a plurality of elongate screening elements arranged in spaced relationship transversely on the support structure to define elongate screening apertures between adjacent screening elements, each screening element having a screening head defining a screening surface with the screening elements being arranged on the support structure so that the screening surfaces of all of the screening elements are at the same height relative to the support structure, the screening elements being arranged in pairs of different widths relative to each other and the screening aperture defined between each of the pairs of adjacent screening elements having a transverse dimension less than a maximum width dimension of a wider of the screening elements, the screening head of at least the wider screening element of each pair being shaped to maintain a substantially constant screening aperture between the pairs of screening elements during a predetermined amount of wear of at least the wider screening element.

The screening elements may be arranged in an alternating format with one screening element having a wider screening head being arranged adjacent a screening element having a narrower screening head. In an embodiment, the screening elements may be arranged in pairs so that the screening aperture between the screening elements of the pair is narrower than the screening aperture between adjacent pairs of screening elements.

The support structure may comprise a plurality of spaced, parallel bars to which the screening elements are attached. Each screening element may be attached to the bars by welding.

With reference to the second embodiment of the disclosure, the bars may be arranged to form a cylinder with the screening elements being attached to an operatively outer edge of the bars in some embodiments and to an operatively inner edge of the bars in other embodiments. The bars may extend longitudinally and may be circumferentially spaced with the screening elements extending substantially orthogonally relative to the bars.

With reference to the second embodiment of the disclosure, the screening aperture defined between each of the at least some pairs of adjacent elements may have a transverse dimension less than a maximum width dimension of a wider of the screening elements of the pair of screening elements.

### BRIEF DESCRIPTION OF DRAWINGS

Embodiments of the disclosure are now described by way of example with reference to the accompanying drawings in which:

FIG. 1 shows a perspective view of an embodiment of a screen;

FIG. 2 shows a sectional end view of a part of a first embodiment of a screen;

FIG. 3 shows, on an enlarged scale, a part of the screen of FIG. 2 circled by Circle ‘A’ in FIG. 2 of the drawings;

FIG. 4 shows a sectional end view of a part of a second embodiment of a screen;

FIG. 5 shows a perspective, sectional view of another embodiment of a screen;

FIG. 6 shows a perspective view of a further embodiment of a screen; and

FIG. 7 shows a perspective, sectional view of a segment of the screen of FIG. 6.

### DETAILED DESCRIPTION OF EXEMPLARY EMBODIMENTS

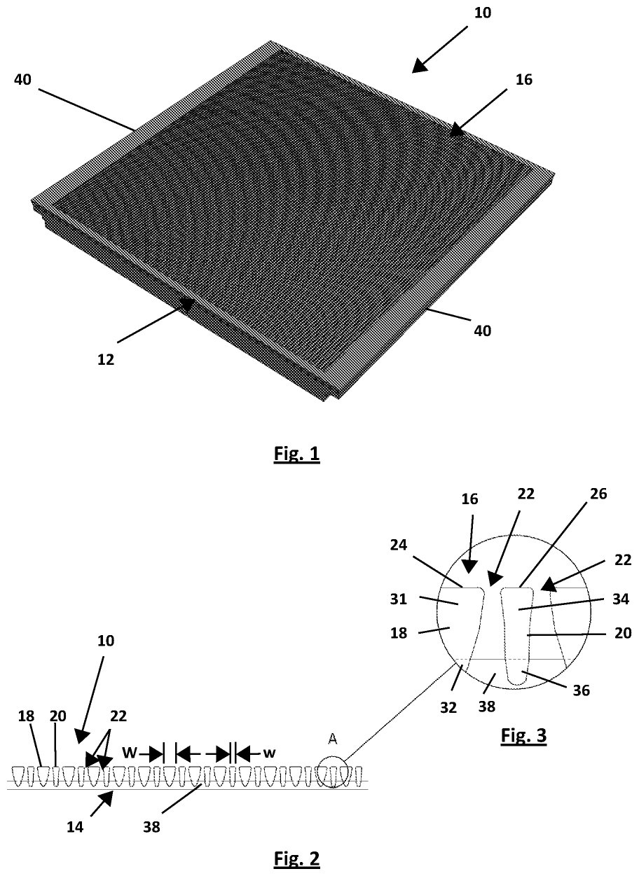

Referring initially to FIG. 1 of the drawings, reference numeral 10 generally designates a first embodiment of a screen in the form of a screening panel. Such a screening panel 10 is typically used in mineral processing applications such as ore particle classification. The screening panel 10 comprises a frame 12 bounding a support structure 14 (FIG. 2). A screening surface 16 of the screening panel 10 is defined by a plurality of discrete, elongate screening elements 18, 20 (FIG. 2).

In the embodiments illustrated in FIGS. 1-4 of the drawings, each elongate screening element 18, 20 is in the form of a length of rectilinear rod or wire with the screening elements 18, 20 being arranged in spaced, parallel relationship to define a slot-shaped screening aperture 22 between adjacent screening elements 18, 20.

In an embodiment, each screening element 18, 20 is in the form of a length of Vee-Wire® (Vee-wire is a registered trade mark of Johnson Screens, Inc. of 2000 St James Place, Houston, Tex., 77056, USA). In other embodiments, instead of the screening elements 18, 20 being substantially V-shaped, the screening elements 18, 20 may adopt other configurations, for example, square or rectangular or other polygonal shape, in vertical cross-section, to define different shapes of screening apertures for different applications.

Each screening element 18 defines a screening surface 24 (FIG. 3). Likewise, each screening element 20 defines a screening surface 26. The screening surfaces 24 and 26 of the screening elements 18 and 20, respectively, form the screening surface 16 of the screening panel 10. The screening elements 18 and 20 are arranged on the support structure 14 so that the screening surfaces 24 and 26 of the screening elements 18 and 20, respectively, are arranged at the same height relative to the support structure 14 to define a substantially planar screening surface 16.

While the illustrated embodiment of the screening panel 10 shown in FIGS. 2-4 of the drawings shows all the screening surfaces 24, 26 being at the same height across the full screening surface 16 of the screening panel 10, it will be appreciated that, in other embodiments, only some of the screening surfaces 24, 26 may be arranged at the same height whereas some of the other screening surfaces may be arranged at different heights relative to each other and to the support structure 14.

It is to be noted that, when viewed end on, the screening elements 18 define a first width ‘W’ whereas the screening elements defining a second width ‘w’. The width W is greater than the width w. In the illustrated embodiment, the screening elements 18 and 20 alternate with respect to each other so that each screening aperture 22 of the screening panel 10 is defined between a pair of spaced screening elements 18 and 20. Once again, it will be appreciated that, in other embodiments only some of the screening apertures 22 may be defined between alternating wider screening elements 18 and narrower screening elements 20 with remaining screening apertures 22 either being defined between pairs of adjacent wider screening elements 18 or pairs of adjacent narrower screening elements 20.

Further, as shown in the embodiment illustrated in FIGS. 2 and 3 of the drawings, the screening aperture 22 defined between each pair of screening elements 18 and 20 is the same width as the screening aperture 22 defined between adjacent pairs of screening elements 18, 20. In other words, all screening apertures 22 of the screening panel 10 of the embodiment illustrated in FIGS. 2 and 3 of the drawings are of the same width.

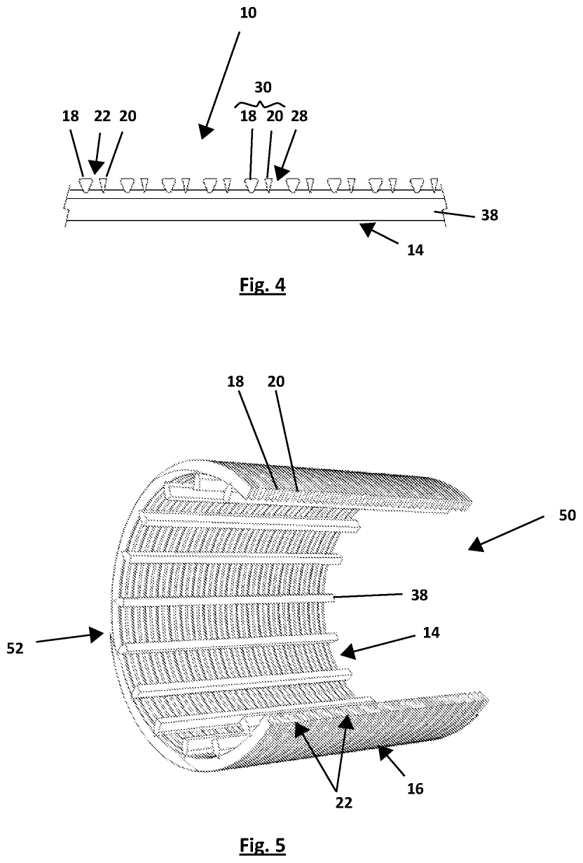

In the embodiment of the disclosure illustrated in FIG. 4 of the drawings, the width of the screening aperture 22 between each pair of screening elements 18 and 20 is less than the width of a screening aperture 28 between pairs 30 of screening apertures 18, 20.

As indicated above, each screening element 18 is in the form of a shaped wire having a screening head, or head portion, 31 (FIG. 3 of the drawings) integrally formed with a root portion 32 via which each screening element 18 is secured to the support structure 14. Similarly, each screening element 20 has a screening head, or head portion, 34 integrally formed with a root portion 36 via which the screening element 20 is secured to the support structure.

In embodiments where the root portions 32 and 36 of the screening elements 18 and 20, respectively, differ in profile, the screening elements 18 and 20 are welded to the bars 38 of the support structure so that the screening surfaces 24 and 26 lie in the same plane.

The screening panel 10 of FIG. 1 of the drawings has a steel frame 12 coated with a suitable plastics material such as a polyethylene plastics. The screening elements 18 and 20 are suitable steel elements, for example, of 304 stainless steel. It will be appreciated, however, that other suitable grades of stainless steel or other steel or plastics material could be used in appropriate applications.

The screening panel 10 is substantially square when viewed in plan having a screening area of approximately 610 mm×610 mm. The screening aperture 22 has a transverse dimension, or width, which is less than a maximum width dimension of the head portion 31 of the screening element 18 and is, typically, less than about 1.5 mm. In some embodiments, the width of the screening aperture 22 is about 1 mm but may be as narrow as 0.5 mm depending on the application of the screening panel 10. Thus, the screening aperture 22 may have a width falling in any of the following ranges: 0.1 mm-0.3 mm; 0.3 mm-0.5 mm; 0.5 mm-0.7 mm; 0.7 mm-0.9 mm; 0.9 mm-1.1 mm; 1.1 mm-1.3 mm or 1.3 mm-1.5 mm. It will be understood that, where reference is made to any range, the range includes all values falling within the range, including the end values.

In the embodiment illustrated in FIG. 4 the drawings, the screening aperture 22 may have any of the dimensions as set out in the preceding paragraph. However, the screening aperture 28 is wider than that of the screening aperture 22 and, for example, may be about double the width of the screening aperture 22.

It will be appreciated that, by having alternating screening elements 18, 20, a larger number of screening elements can be accommodated on the support structure 14 than if all the screening elements were of the same width as the screening elements 18. Therefore, the open area of the screening panel 10, i.e. the area defined by the sum of the screening apertures 22, or screening apertures 22 and 28, as the case may be, is considerably greater than a screening panel 10 made up solely of screening elements 18.

It will further be appreciated that the wider the screening head of each screening element, the greater its impact resistance is. Accordingly, by alternating screening elements 18 and 20, greater impact resistance is provided by the screening elements 18 while still providing an increased open area in comparison with screening panels having screening elements of uniform width. Where alternating screening elements 18 and 20 are provided across the full screening surface 16 of the screening panel 10, an increase in open area of up to 50% may be able to be obtained assuming the screening element 20 has a head portion 26 which is half the width of the head portion 24 of the screening element 18.

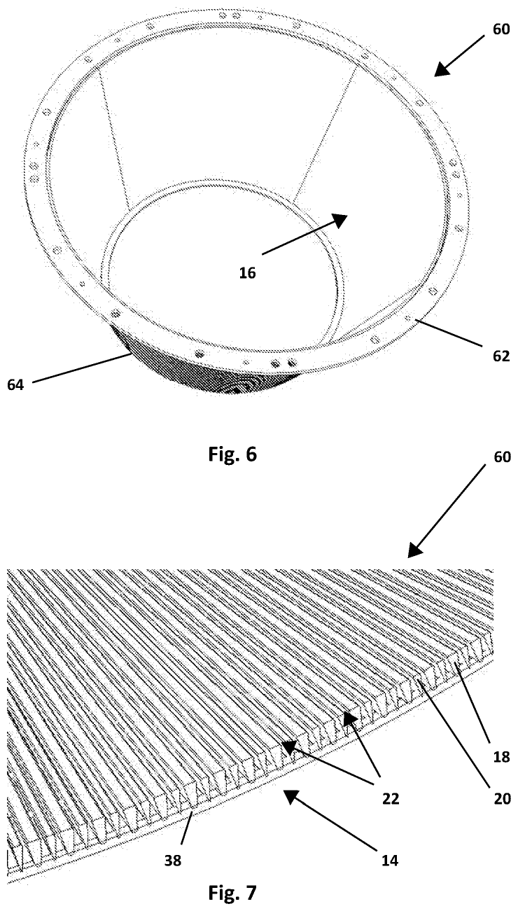

With reference to FIG. 5 of the drawings, reference numeral 50 generally designates a further embodiment of a screen. With reference to FIGS. 1-4 of the drawings, like reference numerals refer to like parts, unless otherwise specified.

In this embodiment, the screen 50 is in the form of a right, circular cylinder 52, with the screening surface 16 being defined on an outer surface of the cylinder 52. The structure of the screening surface 16 of the cylinder 52 of the screen 50 is similar to that of the screening panel 10 of FIGS. 1-3 or FIG. 4 of the drawings. Thus, the cylinder 52 is defined by a support structure 14 comprising a plurality of spaced parallel bars 38 extending parallel to a longitudinal axis of the cylinder, the bars 38 being circumferentially spaced from each other.

The bars 38 of the support structure 14 support a plurality of longitudinally spaced, circumferentially extending screening elements 18 and 20, the screening elements 18 and 20 being arranged as per the embodiments of the screening panel 10 described above.

The screen 50 of this embodiment can be used in various applications such as water well screens for screening water. However, the screen 50 can also be used as a trommel screen for screening particulate material to classify that material. The trommel screen can be used in numerous applications, including food preparation and/or processing as well as in mineral processing and waste water processing applications.

While the screen 50 has been illustrated with the screening elements 18 and 20 being shown on the outside of the support structure 14, it will be appreciated that, in some applications, the screening elements 18 and 20 may be arranged inside the support structure 14 so that the screening surface 16 forms an inner surface of the cylinder 52. Still further, in other applications, the screening elements 18 and 20 may be spirally wound about the support structure 14, whether inside or outside the support structure 14. In still further applications, the bars 38 of the support structure 14 may be arranged as axially spaced circumferentially arranged rings with the screening elements 18, 20 extending axially either inwardly of the support structure 14 or externally of the support structure 14.

Referring to FIGS. 6 and 7 of the drawings, a further embodiment of a screen is illustrated and is designated generally by the reference numeral 60. Once again, with reference to FIGS. 1-4 of the drawings, like reference numerals refer to like parts, unless otherwise specified.

The support structure 14, once again, comprises a plurality of spaced support bars, one of which is visible at 38, in FIG. 7 of the drawings. The support structure 14 is arranged to define a frustum-shaped screening surface 16 (FIG. 6). As in the case of the previous embodiments, the screening surface 16 is defined by head portions of a plurality of the elongate screening elements 18 and 20. Adjacent screen elements 18 and 20 define screening apertures 22 between them.

In the illustrated embodiment, the support bars 38 of the support structure 14 are axially spaced and extend circumferentially about an outer surface of the screening elements 18, 20. The screening elements 18, 20 extend between opposed ends 62, 64 of the screen 60. It will, however, be appreciated that, in other embodiments, the support bars 38 of the support structure 14 may extend between the ends 62, 64 of the screen 60 with the screening elements 18, 20 extending circumferentially and being axially spaced relative to each other. Still further, in other applications, the screening elements 18, 20 may be arranged on an outside of the support structure 14, rather than the inside, as illustrated. Still further, in other applications, the screening elements may extend transversely, but not orthogonally, relative to the support bars 38 and/or the ends 62, 64 of the screen 60.

The screen 60 of FIGS. 6 and 7 has application in various industries including as a centrifuge basket in removing moisture from slurries as well as applications in the food industry in foodstuffs processing and preparation.

It is an advantage of the described embodiments that a screening panel 10 or screen 50 is provided which, due to its increased open area per unit panel size, results in increased media recovery while reducing media losses. It is a further advantage of the described embodiments that a screening panel 10 or screen 50 is provided which results in improved filtering capacity by increasing percentage open area without increasing aperture size.

By appropriately shaping the head portion 24 of each of the screening elements 18, increased wear of the screening elements 18 and 20 can be accommodated. In other words, the head portion 24 of the screening elements 18 can be shaped so that as the screening surface 16 wears away, the width of the screening aperture 22 remains substantially constant for a greater length of time to maintain the desired classification efficiency of the screening panel 10 for a longer period of time. Classification efficiency is governed by the ratio of near size and undersize particles to oversize particles passing through the screening apertures 22 of the screening panel 10/screen 50. The classification life of the screening panel 10/screen 50 is also improved over conventional screening panels due to the wider screening elements 18 shielding the narrower screening elements 20 against wear.

This increases the life of the screening panel 10/screen 50 reducing the frequency of “change out” required. The need for “change out” occurs where a cut point, i.e. the size of fraction passing through the screening apertures, exceeds a permissible size. The shielding effect provided by the screening elements 18 to the screening elements 20 facilitates the screening panel 10 remaining within specification for a greater period of time.

In water well applications, by having an increased open area, a greater hydraulic capacity is able to be achieved. As a result, substantial cost savings in drilling smaller boreholes and casing such smaller boreholes can be realised.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A screen which includes a support structure; and a plurality of elongate screening elements arranged in spaced relationship transversely on the support structure to define elongate screening apertures between adjacent screening elements, each screening element having a screening head defining a screening surface with the screening elements being arranged on the support structure so that the screening surfaces of all of the screening elements are at the same height relative to the support structure, the screening elements being arranged in pairs of different widths relative to each other and the screening aperture defined between each of the pairs of adjacent screening elements having a transverse dimension less than a maximum width dimension of a wider of the screening elements, the screening head of at least the wider screening element of each pair being shaped to maintain a substantially constant screening aperture between the pairs of screening elements during a predetermined amount of wear of at least the wider screening element.

2. A screen which includes a support structure which has the form of one of: a cylinder and a frustum; and a plurality of elongate screening elements arranged in spaced relationship transversely on the support structure to define elongate screening apertures between adjacent screening elements, each screening element having a screening head defining a screening surface with the screening elements being arranged on the support structure so that the screening surfaces of all of the screening elements are at the same height relative to the support structure, the screening elements being arranged in pairs of different widths relative to each other and the screening aperture defined between each of the pairs of adjacent screening elements having a transverse dimension less than a maximum width dimension of a wider of the screening elements, the screening head of at least the wider screening element of each pair being shaped to maintain a substantially constant screening aperture between the pairs of screening elements during a predetermined amount of wear of at least the wider screening element.

3. The screen of claim 1 in which the screening elements are arranged in an alternating format with one screening element having a wider screening head being arranged adjacent a screening element having a narrower screening head.

4. The screen of claim 3 in which the screening elements are arranged in pairs so that the screening aperture between the screening elements of the pair is narrower than the screening aperture between the pairs of screening elements.

5. The screen of claim 1 in which the support structure comprises a plurality of spaced, parallel bars to which the screening elements are attached.

6. The screen of claim 5 in which each screening element is attached to the bars by welding.

7. The screen of claim 5 in which the bars are arranged to form a cylinder with the screening elements being attached to an operatively outer edge of the bars.

8. The screen of claim 7 in which the bars extend longitudinally and are circumferentially spaced with the screening elements extending substantially orthogonally relative to the bars.

9. The screen of claim 1 in which the screening aperture defined between each of the pairs of adjacent elements has a transverse dimension of less than about 1.5 mm.

10. The screen of claim 2 in which the screening elements are arranged in an alternating format with one screening element having a wider screening head being arranged adjacent a screening element having a narrower screening head.

11. The screen of claim 10] in which the screening elements are arranged in pairs so that the screening aperture between the screening elements of the pair is narrower than the screening aperture between the pairs of screening elements.

12. The screen of claim 2 in which the support structure comprises a plurality of spaced, parallel bars to which the screening elements are attached.

13. The screen of claim 12 in which each screening element is attached to the bars by welding.

14. The screen of claim 12 in which the bars are arranged to form a cylinder with the screening elements being attached to an operatively outer edge of the bars.

15. The screen of claim 14 in which the bars extend longitudinally and are circumferentially spaced with the screening elements extending substantially orthogonally relative to the bars.

16. The screen of claim 2 in which the screening aperture defined between each of the pairs of adjacent elements has a transverse dimension of less than about 1.5 mm.
